(19) United States
(12) Patent Application Publication
(10) Pub. No.: US 2010/0098250 A1
(43) Pub. Date: Apr. 22, 2010

(54) MOVIE BASED FORENSIC DATA FOR DIGITAL CINEMA

(76) Inventors: Mark Alan Schultz, Carmel, IN (US); Gregory William Cook, Lafayette, IN (US)

Correspondence Address: Robert D. Shedd, Patent Operations;THOMSON Licensing LLC, P.O. Box 5312, Princeton, NJ, 08543-5312, US

(21) Appl. No.: 12/451,284

(22) PCT Filed: May 8, 2007
(86) PCT No.: PCT/US07/11175

§ 371 Date: Nov. 4, 2009

(51) Int. Cl. H04N 7/167

(52) U.S. Cl. 380/200

(57) ABSTRACT

A method and apparatus are described for embedding information in digital cinema content, including accepting a scene from a digital cinema content file, selecting a scene object in the scene to be modified with the information, determining a characteristic for the selected scene object and generating a scene build based on the characteristic, wherein the characteristic is representative of the information. The method and apparatus further include time-stamping, compressing and storing the scene build. Further, a method and apparatus are described for embedding forensic information in digital cinema content, accepting a digital cinema content file having therein a plurality of scene builds, accepting a forensic code and selecting a scene build from the digital cinema content file based on the forensic code. The scene build, having forensic information, is thereafter displayed.

### FIELD OF THE INVENTION

The present invention relates to forensic marking of digital cinema without fidelity loss.

### BACKGROUND OF THE INVENTION

Most of today's printed films are being marked with special dots, colors, and symbols that are used to create a unique marking for the specific film print that is being shown in the theatre. These marks are being captured by the camcorders in the pirated films. The studios analyze the pirated videos to recover the markings found on the content. These marks are then looked up in a table to find what theatre was sent this particular film print and then an investigation is conducted.

Digital cinema is also looking at adding forensic information in the form of watermarks. As used herein, forensic information (forensics) is information used to detect and prove piracy of digital cinema content. This may be performed at the studio during the mastering/authoring process or may be done at the theater “on the fly” while the content is being projected. As used herein “/”, denotes alternative names for the same or like components. That is, “/”, can be taken to mean “or”. The watermarks should be collected on the pirated video but usually are very subtle so as not to distract from the movie while the paying audience is watching the movie play. The watermarks can be extracted from the pirated video by special signal processing, which normally reveals a series of codes that can be decoded into whatever the information the studio chose to encrypt in the watermark. No matter how subtle, however, the watermarks will still render some part of the images untrue to the original content.

There are two main problems with both of these techniques: first is the amount of manpower and processing required to recover the forensic information. Since this is video, many of the systems require real time searches to locate the markings and then very special processing to recover the marks. This is a very costly process. When many pirated films appear on the markets, the amount of money needed to recover the information for every pirated film becomes prohibitive so studios stop working on forensic identification due to lack of funds. Secondly, both visible and “invisible” watermarks degrade the content to a certain extent. It is not even clear that creating an “invisible” watermark in digital cinema content would survive in a lower resolution camcorder recording.

It would be advantageous to have a method and apparatus for forensically marking digital cinema content so that pirating is easy and inexpensive to identify and which does not degrade the digital cinema viewing experience.

### SUMMARY OF THE INVENTION

Printed films have used simple binary codes in the data for years. The simple embedding techniques are low cost but there is a very high recovery cost in terms of actual manual labor as well as record keeping overhead. The present invention is directed to a much more useful method to fight digital cinema content piracy by displaying very useful and perhaps obvious forensic information displayed directly on the pirated video.

In order to combat video piracy, in accordance with the principles of the present invention, digital cinema content can be forensically marked so that the location of where a pirated video was captured can be determined. The present invention uses movie content provided by the studios to alter what pictures or scene segments are used during the movie, possibly changing each time that the movie is shown/displayed/presented/projected. By altering the content at full picture levels, the audience will not see the forensic marks. Correspondingly, the pirates will not know where the forensic marks are occurring. And sophisticated equipment will not necessarily have to be used to decode the forensic data on the pirated copies. In addition, there is no degradation of the digital cinema content/video itself, so that very high quality digital cinema content, e.g., 12-bits per color component and 4096×2160 pixels, may be enjoyed at the greatest dynamic range without fear of a loss of fidelity.

The present invention involves the studios when building the forensic movie content by adding subtle differences in the digital cinema content so that each time a movie is displayed/played, the resulting sequence of pictures is different in the length of a scene, the objects in a scene, or the actions in a scene. Since the movie content is still from the studios, the audience will not have the picture quality degraded by irritating marks that the film marking system used in the past. Depending on the system, the selection of the forensic information can be done in real time/on the fly at the time of presentation or the studios could master unique copies to be sent out to a specific location that would have the forensic information fixed/static on that particular content.

A method and apparatus are described for embedding information in digital cinema content, including accepting a scene from a digital cinema content file, selecting a scene object in the scene to be modified with the information, determining a number of characteristics for the selected scene object and generating a scene build based on one of the characteristics, wherein the characteristics are representative of the information. The method and apparatus further include time-stamping, compressing and storing the scene build. Further, a method and apparatus are described for embedding forensic information in digital cinema content, accepting a digital cinema content file having therein a plurality of scene builds, accepting a forensic code and selecting a scene build from the digital cinema content file based on the forensic code. The scene build having forensic information is thereafter displayed.

### BRIEF DESCRIPTION OF THE DRAWINGS

The present invention is best understood from the following detailed description when read in conjunction with the accompanying drawings. The drawings include the following figures briefly described below:

FIG. 1 depicts the method for building a scene.

FIG. 2A is a flowchart of the method at a post-production service provider in accordance with the principles of the present invention.

FIG. 2B illustrates exemplary results of the method of FIG. 2A.

FIG. 2C is a schematic diagram of an exemplary embodiment of a post-production apparatus in accordance with the principles of the present invention.

FIG. 3 illustrates an exemplary storage arrangement of the scene builds in accordance with the principles of the present invention.

FIG. 4A is a flowchart of the method at a theater in accordance with the principles of the present invention.

FIG. 4B is a schematic diagram of an exemplary embodiment of the present invention.

FIG. 5 depicts an exemplary forensic segment in a scene of digital cinema content.

### DETAILED DESCRIPTION OF THE PREFERRED EMBODIMENTS

The Digital Cinema System Specification has security provisions that contain both forensic data and security information on screen, location, time, date and film content. Digital cinema permits the addition of special information (such as forensic information) to content that was not previously possible with conventional film techniques. All of this data can be used for small lookup tables to produce a code such as the following example:

Given 16 screens (2 digits), 1000 locations (four digits), 24 hours, 7 days, 12 months, and a given year, a lookup table is used to produce a unique pattern for a specific viewing. One example would be screen #04 (screen inside a specific theatre), location #0249 (Glendale Shopping Center in Indianapolis), #14 for hours (2 pm), #3 for days (Wednesday), #04 for month (April), #07 for year (2007). The code would be 04-0249-14-3-04-07 or 0402491430407. Another variation could use a code for the day of the month (1-31) as well as or instead of the day of the week where the digit “10” could be coded as an “a”, digit “11” coded as a “b”, etc. using as many different symbols (including foreign characters) as necessary. This could be encrypted with another algorithm or used directly. To use the above code directly, the 14 digits are mapped to optional scenes by letter (0=a, 1=b, . . . ) and then repeated to present/show/display the forensic content in the following order:

| scene# | code# | selected scene | unused scenes |
|---|---|---|---|
| 1 | 0 | selects forensic scene 1a | 1b, 1c, 1d, . . . |
| 2 | 4 | selects forensic scene 2e | 2a, 2b, 2c, 2d, 2f, 2g, . . . |
| 3 | 0 | selects forensic scene 3a | 3b, 3c, 3d, 3e, . . . |
| 4 | 2 | selects forensic scene 4c | 4a, 4b, 4d, 4e, . . . |
| 5 | . . . | | |

In the event that a particular scene did not have enough different scene builds, then the code could be wrapped around in a modulo fashion. For example, still using the above code, scene 6 would need at least 10 different scene builds. If there were not 10 different scene builds of scene 6, but only 6 different scene builds (a-f), then the code “9” would get scene build “d” because the codes would wrap around modulo 5. The same result would be appropriate if the day of the month was used. The forensic code found in the digital stream can also be used as source to control the scene selections along with the time and date of the actual play time. This is similar to the repeated use of the same code in a modulo fashion. That is, since the above code/key has 14 digits, then scene 15 starts over again using the first digit of the code.

The algorithm receives the code number and proceeds to control the bit stream to play the selected forensic scene segment such as 1a, 2e, . . . and does not use the remaining forensic segments of 1b, 1c, 1d, 2a, 2b, . . . for this showing. On a hard drive, this is a simple process of reading the streaming data from one location (scene #1), jumping to the location of the next selected scene and streaming it (scene #2c), and then jumping to the next standard location (scene #3).

Since the time codes match in each of the forensic segments, the stream will play without errors. The rate control may be an issue due to additional forensic streams being introduced into a limited bandwidth system but this issue can be dealt with by keeping the forensic segments small in number and simple in content. When done properly, all digital cinema standards can be honored during the presentation or showing while making a unique presentation that has completely invisible forensic content. This forensic information is very visible to the naked eye when specifically watching for the forensic scenes segments.

The recovery of the forensic information can also be automated since each location of the forensic marks is known by the studio and each selected scene could have its own spectral profile at each location. Retailers could also use this concept when sending out DVDs as a unique disk where the forensic information is already in place or by mastering a DVD that is partnered with a secure processor that makes a unique showing real time via the secure processor. The identification (ID) of the processor could be recovered via the forensic information which then could to be traced back to an individual or a uniquely registered box.

By using the standards for digital cinema and adding some controls, we can alter the movie content in a subtle manner so a trained eye will be able to extract the forensic markings directly from the pirated video or simplify their automated searches.

The idea is to create multiple sequences of multiple scenes (called scene versions/variations/builds), each with subtle differences in the content. These differences/characteristics could be the coloration of specific items, variations in the objects shown in each scene, or perhaps a difference in the length of a scene each time the movie is shown.

The structure of the movie content for the present invention is very similar to a program stream for DVD playback where parallel clips are available inside the projector. The projector will pick one of the possible streams in many different places during the actual playback to make a unique showing of the movie play. When the content is stored on disc drives or other random access medium, this process of forensic selection can be performed in real time/on the fly in a theatre or performed at a much faster time when authoring DVDs or writing to another hard drive. Since the streams are mastered at the same time and are full movie content, the audience will not see annoying artifacts such as dots or degraded objects in the movies. Meanwhile the pirate would have to compare, on a frame by frame basis, two different video captures to visually inspect the content for the forensic marks since they are encrypted by means of the normal movie scenes and not an added mark to the content. This method would also work for audio clues such as background sounds or voices.

The present invention is also adaptable for use on any movie by cutting out small clips of the content occasionally or introducing different sounds but this introduces some serious synchronization issues with the timestamps, audio/video lip-sync, and the subtitles synchronization. However, if only the video objects in the scenes are altered and the substitutions occur in a one-for-one frame swap, then no synchronization issues will exist. If required, the synchronization issues of differing scene lengths can be addressed by limiting the switching times to areas where the data is synchronized properly for switching or the introduction of additional synchronization markers in the content just for this purpose.

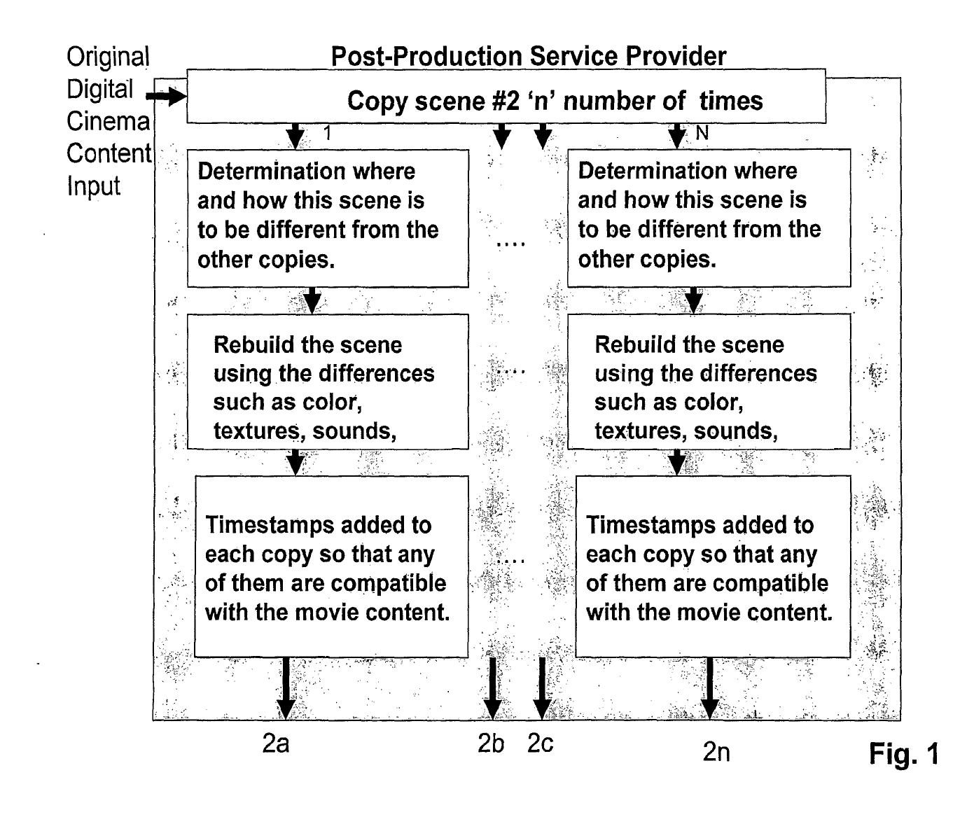

FIG. 1 depicts the method for building a scene. For a given scene an object such as a car in the background is selected and it is colored in accordance with a selected set of colors. The selected set of colors may or may not be tied to the colors available for that particular model that particular year. That is, for a given make and model, teal green may be an option for color but that car make and model may not have had teal green as an available color that year. The selected color set may be limited only by the colors available to be displayed rather than the actual colors available from the manufacturer for that year's make and model. The object selected could just as easily be the background music that is being played. For example, the scene may involve two people sitting in a car carrying on a conversation and the background audio on the car radio (music etc. . . . ) could be different for each scene build. Given the amount of music available, the number of scene builds for such an object is almost infinite.

A scene is picked to replicate and the item to differentiate the scene is selected. The main scene clip is copied into multiple clips and each one processed slightly differently with emphasis on the selected item. If the selected item is a car moving in the background, today's technology can change the color of the car with special tracking software so that only the car needs to be selected, the color chosen, and then the software will provide the remaining effort to recolor the car during the entire time it is on the screen. Forensics normally work on subtle differences in the film to make the process simple. In this case, the car that is selected is normally not the main car in the scene and the audience can see it but their attention is elsewhere. If the same car appears in another scene when it is a different color, the audience would naturally assume it is another car. Generally speaking, color memory is not very well developed in humans and the change would go unnoticed by a vast majority of the audience. The next scene version/build/variation is then processed with another color for the car and so on. Each scene is then JPEG 2000 compressed exactly the same as all of the digital cinema content so no difference is found on the quality of each separate scene variation/version/build. Any other appropriate compression means may be used.

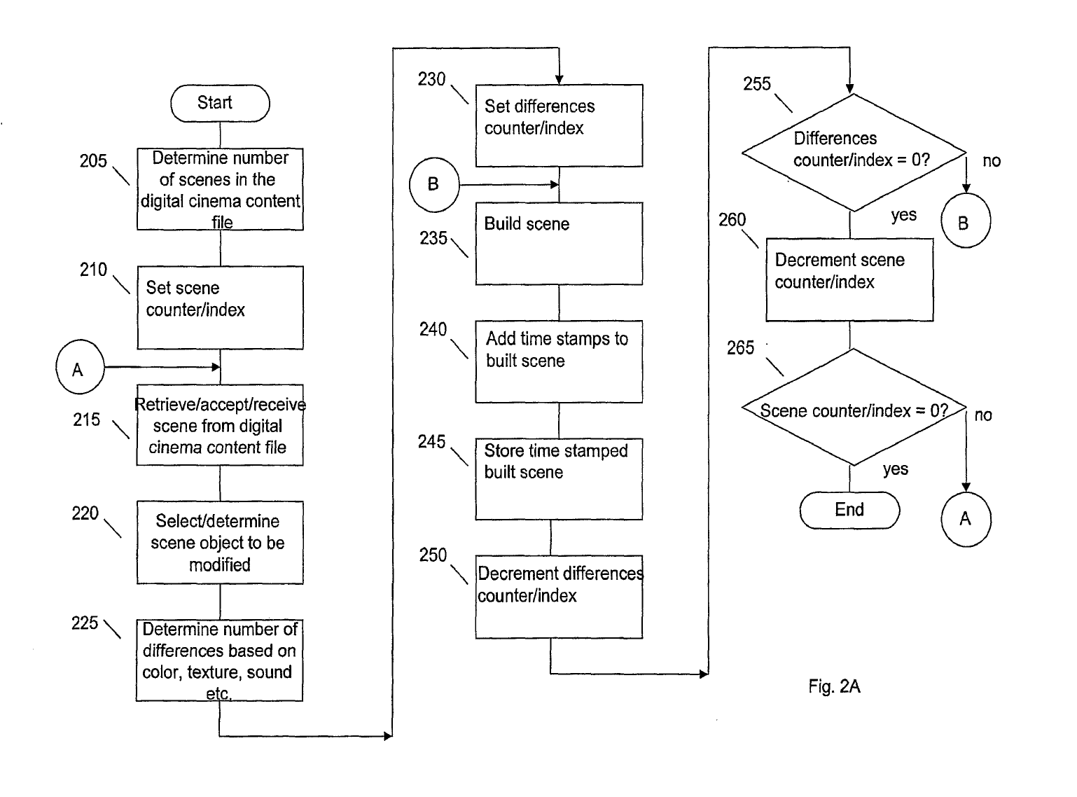

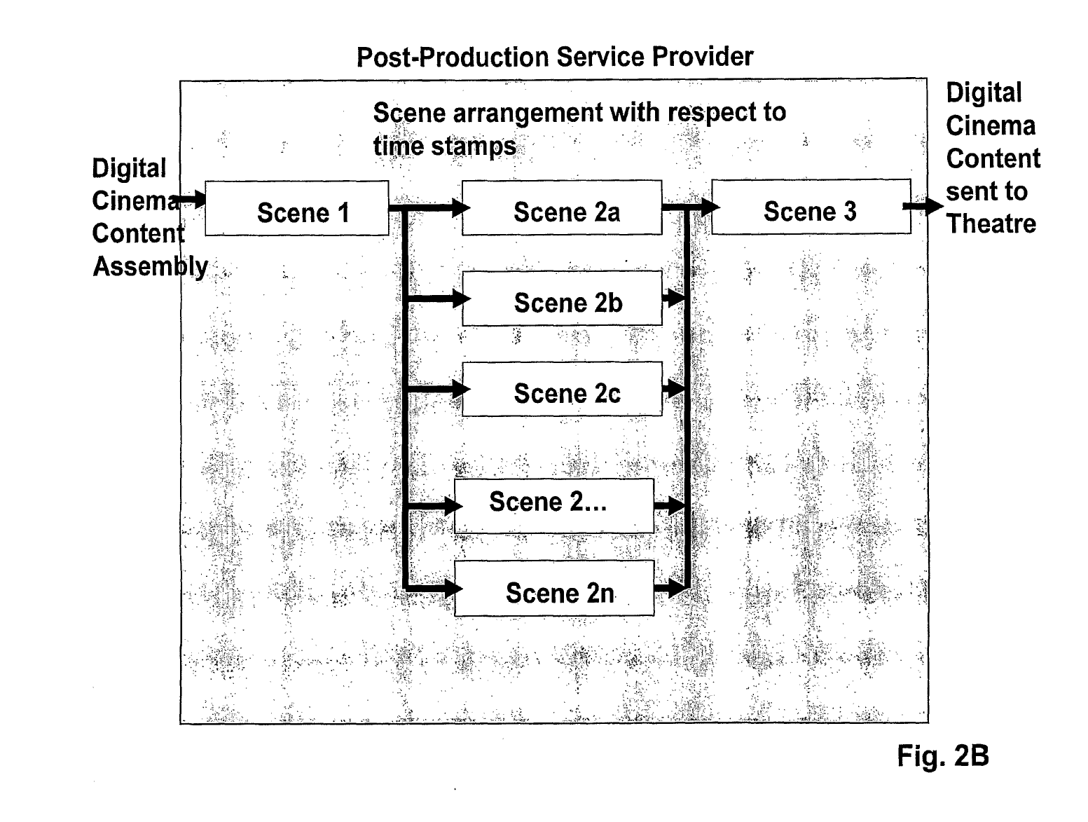

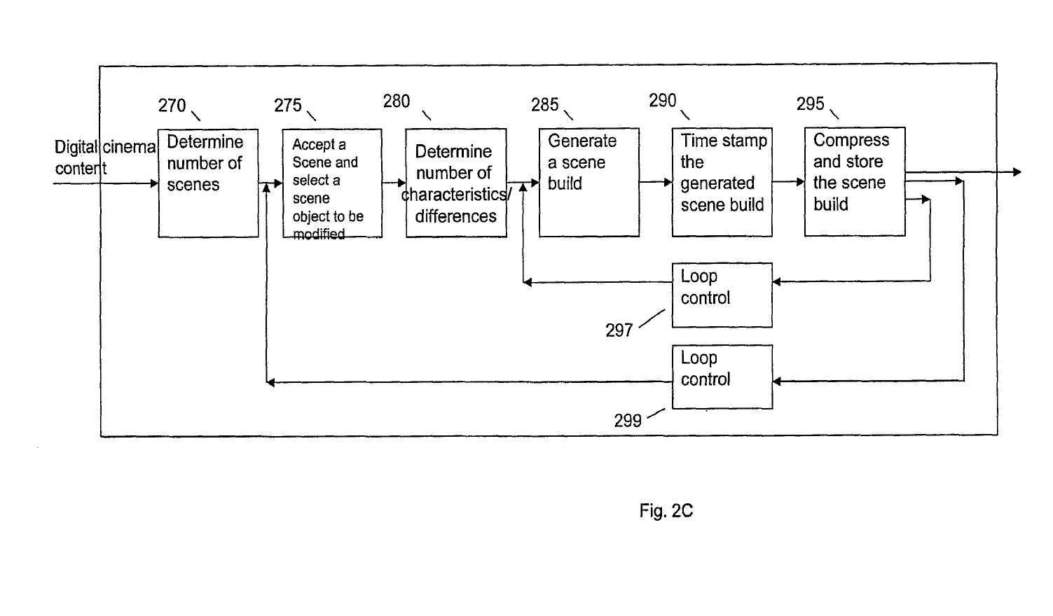

FIG. 2A is a flowchart of the method at a post-production service provider in accordance with the principles of the present invention. The number of scenes in the digital cinema content file is determined at 205. This may be accomplished by counting the number of scenes in the file or it may be provided in the file header or by any other reasonable and appropriate means. A scene counter/index is then set at 210 indicative of the number of scenes in the digital cinema content file. This may be an up-counter initialized to zero, which is used to count up to the number of scenes or a down-counter used to count down to zero from the number of scenes or any other reasonable and appropriate means. A down-counter was chosen for this exemplary embodiment of the present invention. A scene is then accepted/received/retrieved from the digital cinema content file at 215. The verbs above can be used interchangeably depending on whether the digital cinema content file is transmitted electronically, shipped on a storage medium or any other reasonable and appropriate means. A scene object/segment, such as a car, to be modified is then selected or determined at 220. The number of differences that can be assigned to this scene object/segment based on color, texture sound, etc. is then determined at 225.

A differences counter/index is then set at 230 indicative of the number of differences. Once again this could be an up-counter or a down-counter or any other reasonable and appropriate means. A down counter was selected for this exemplary embodiment of the present invention. As an example, if a car was selected as the scene object/segment the available colors could be selected based on all colors available or as indicated above the colors available by that manufacturer for that make and model for that year.

A scene is then built at 235 and a time stamp is added at 240. The newly built scene is stored at 245 on any reasonable and appropriate storage medium. The differences counter/index is decremented at 250. The differences counter/index is tested at 255 to determine if it is zero. If the differences counter/index is not zero then another scene is built staring at 235. If the differences counter/index is zero then the scene counter/index is decremented at 260 and the scene counter/index is tested at 265 to determine if it is zero. If the scene counter/index is not zero then another scene is accepted/received/retrieved from the digital cinema content file at 215. If the scene counter/index is zero then the process is complete for this digital cinema content file.

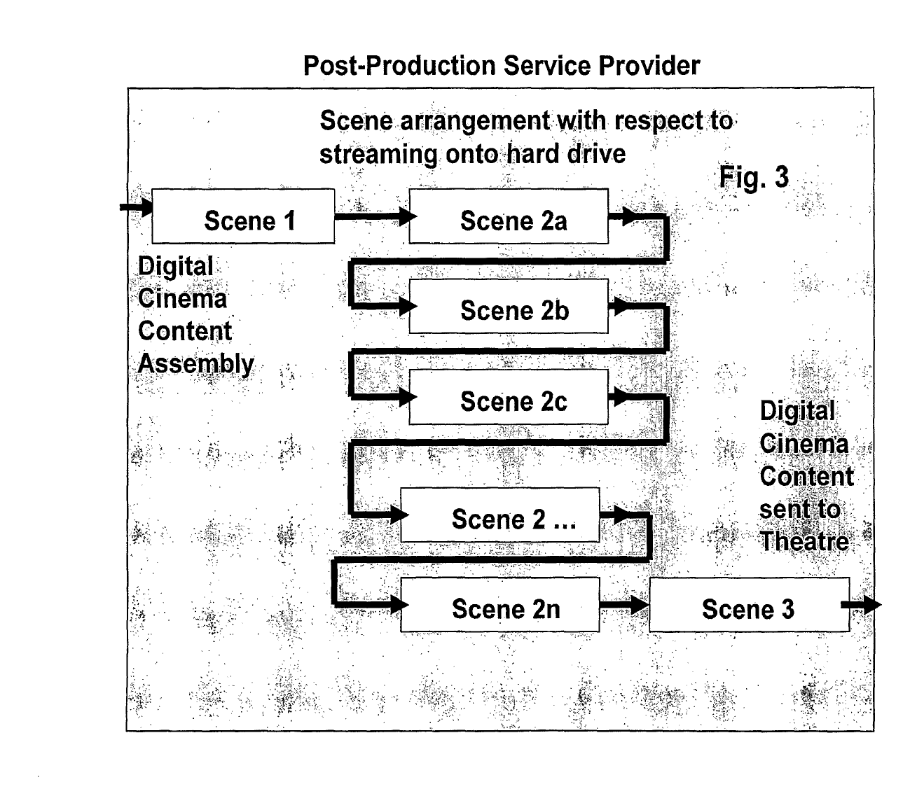

FIG. 2B illustrates exemplary results of the method of FIG. 2A. The scenes are time stamped and assembled as shown in FIGS. 2B and 3. Scene 2 is used as the single scene in this example where “n” different scene builds were generated for scene 2 based on “n” differences for the selected scene object/segment. Each scene build was time stamped after it was built.

FIG. 2C is a schematic diagram of an exemplary embodiment of post-production apparatus in accordance with the principles of the present invention. Module/component 270 accepts digital cinema content and determines the number of scenes in the digital cinema content file. A counter is then set indicative of the number of scenes in the digital cinema content file and used as the control for loop control 299 being adjusted/decremented/incremented and tested (compared) within loop control 299. A scene is accepted/received/retrieved from the digital cinema content file and a scene object/segment is selected to be modified by 275. The number of differences/characteristics is determined by 280. A counter is set indicative of the number of characteristics/differences for the scene object/segment and used as the control for loop control 297 being adjusted/decremented/incremented and tested (compared) within loop control 297. Scene build/version/variation is generated by 285. The scene build generated by 285 is time stamped at 290 and compressed and stored by 295. Components/modules indicated as a single module having multiple functions may be split into multiple components. Similarly multiple modules/components having single functions may be combined into a single component/module.

FIG. 3 illustrates an exemplary storage arrangement of the scene builds in accordance with the principles of the present invention. FIG. 3 depicts the digital cinema content including all of the scene builds for exemplary scene 2 stored on a hard drive or other storage medium. The digital cinema content could be shipped to the theaters on a storage medium or transmitted to the theaters electronically. The digital cinema content could be encrypted prior to electronic transmission or even encrypted on the storage medium. One or more keys (including the forensic code/key) could be sent to the theaters either electronically or on a different storage medium.

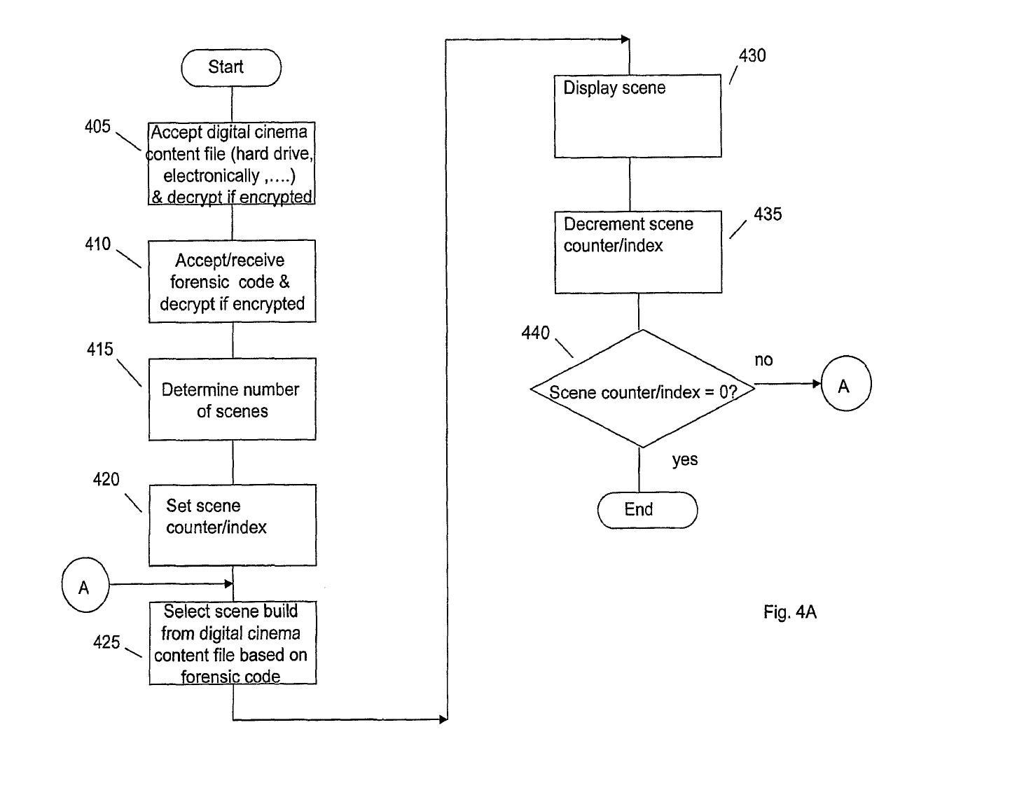

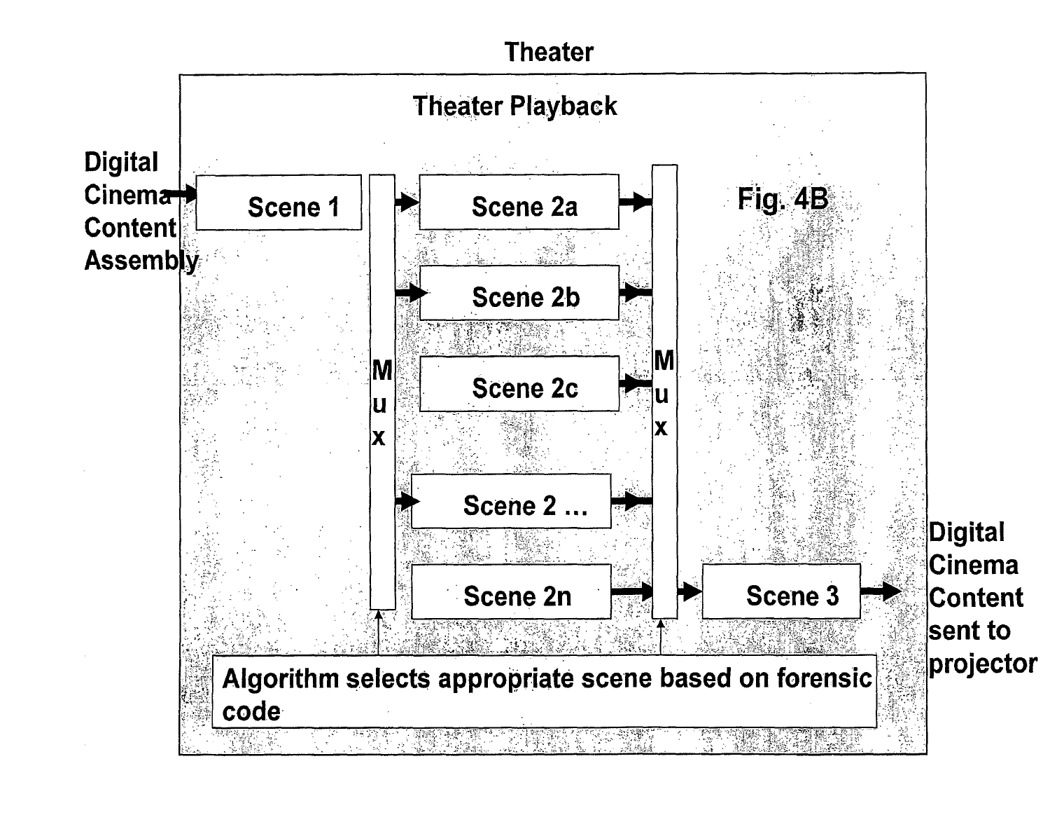

FIG. 4A is a flowchart of the method at a theater in accordance with the principles of the present invention. A digital cinema content file is accepted/received/retrieved at 405 and decrypted with a key if it was encrypted. Similarly, a forensic code is accepted/received/retrieved at 410. The number of scenes in the digital cinema content file is determined at 415. This may be accomplished by counting the number of scenes in the file or it may be provided in the file header or by any other reasonable and appropriate means. A scene counter/index is then set at 420 indicative of the number of scenes in the digital cinema content file. This may be an up-counter initialized to zero, which is used to count up to the number of scenes or a down-counter used to count down to zero from the number of scenes or any other reasonable and appropriate means. A down-counter was chosen for this exemplary embodiment of the present invention. A time stamped scene build is then selected from the digital cinema content file based on the forensic code at 425. As indicated above if there are more digits in the forensic code than there are scene builds available then the scene builds are selected in a “wrap around” modulo manner. The selected scene is then displayed at 430. The term “display” also includes digital projection of the scene. The scene counter/index is then decremented at 435. A test is performed at 440 to determine if the scene counter/index is zero. If the scene counter/index is not zero then another scene build is selected at 425. If the scene counter/index is zero then the process is complete for this digital cinema content file.

FIG. 4B is a schematic diagram of an exemplary embodiment of the present invention. The processing inside the projector at a theater is shown in FIG. 4B where an algorithm in a controller located in the projector determines which scene is displayed for a unique showing. Note that only the projector and the algorithm developer will know which scene (2a, 2b, . . . or 2n) will be selected at the time of the showing. In this exemplary embodiment, multiplexers (muxes) are used for selection of time stamped scene builds. These multiplexers can be reused and need not necessarily be duplicated. Any other reasonable and appropriate means can be used to select the time stamped scene builds from the digital cinema content file. An embodiment of the present invention includes a module for accepting the digital cinema content file, a module for accepting the forensic code, a module for selecting a time stamped scene build from the digital cinema content file based on the forensic code and a module for displaying/digitally projecting the selected time stamped scene build. The processing through the embodiment would be controlled by the number of scenes in the digital cinema content file. The selection module may include mulitplexers or any other reasonable and appropriate selection means. The displaying/digitally projection module may also include a means for decompressing the selected scene build.

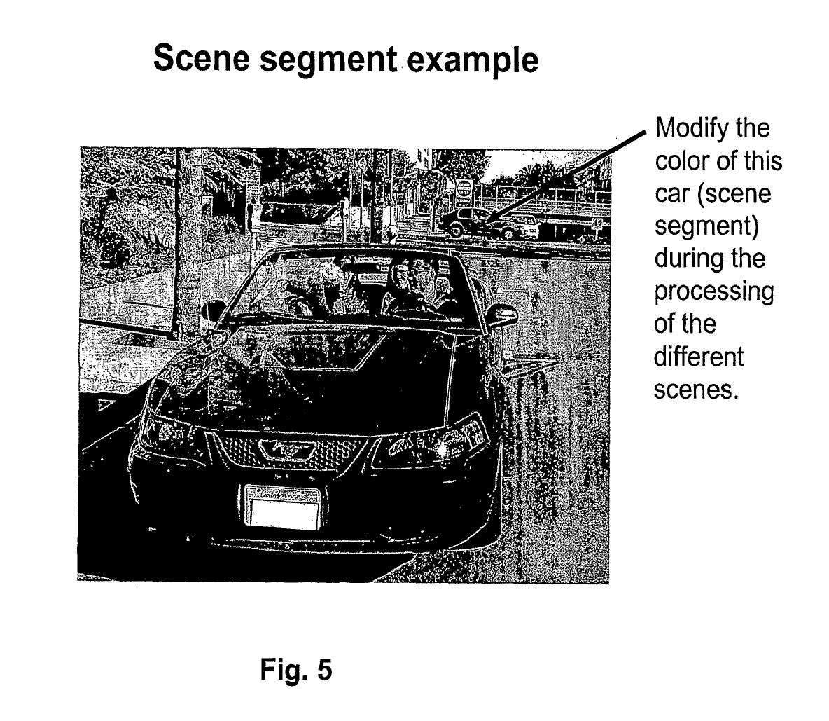

FIG. 5 depicts an exemplary forensic segment in a scene of digital cinema content. In this example, a car was selected as the scene object/segment to be modified. As originally digitally captured (filmed) the car might be red. In another scene build the car might be blue, yellow, black, white, green etc. The colors selected for the scene object/segment might be all of the available colors (maximum based on the number of bits available to encode such) or may be limited by the colors available from the manufacturer for that make and model for that year.

If the selected scenes are kept short, this concept does not significantly increase the size of the total digital cinema content shipped or transmitted to the theaters.

While the method described above requires a special processor for the content, it would be possible to utilize the present invention without requiring a special processor in the projector. In this case, the content that the studio ships or transmits to the theaters would be slightly different as it is delivered to each theater.

It is also possible to have multiple different scenes in the video to extend the number of possible different videos. If each multiple scene had three possible differences and there were twenty such scenes in the movie, this would allow for 14 million different variations. However, to forensically analyze the clip would only require finding 20 specific scenes and determining the object categorization.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for embedding information in digital cinema content, said method comprising:
accepting a scene from a digital cinema content file;
selecting a scene object in said scene to be modified with said information;
first determining a characteristic for said selected scene object; and
generating a scene build based on said characteristic, wherein said characteristic is representative of said information.

2. The method according to claim 1, further comprising:
time-stamping said scene build; and
storing said time-stamped scene build.

3. The method according to claim 2, further comprising:
first setting a counter indicative of said characteristic;
first adjusting said characteristic counter;
first comparing said characteristic counter against a first pre-determined value;
second determining whether said characteristic counter is equal to said first pre-determined value; and
first repeating said generating, said time-stamping and said storing acts if said characteristic counter is not equal to said first pre-determined value.

4. The method according to claim 3, further comprising:
third determining a number of scenes in said digital cinema content file;
second setting a counter indicative of said number of scenes in said digital cinema content file;
second adjusting said scene counter;
second comparing said scene counter against a second pre-determined value;
fourth determining whether said scene counter is equal to said second pre-determined value;
second repeating said accepting, said selecting, said first determining, said generating, said time-stamping, said storing, said first setting, said first adjusting, said first comparing, said second determining and said first repeating acts if said scene counter is not equal to said second pre-determined value.

5. The method according to claim 2, further comprising compressing said scene build.

6. An apparatus for embedding information in digital cinema content, comprising:
means for accepting a scene from a digital cinema content file;
means for selecting a scene object in said scene to be modified with said information;
first means for determining a characteristic for said selected scene object; and
means for generating a scene build based on said characteristic, wherein said characteristic is representative of said information.

7. The apparatus according to claim 6, further comprising:
means for time-stamping said scene build; and
means for storing said time-stamped scene build.

8. The apparatus according to claim 7, further comprising:
first means for setting a counter indicative of said characteristic;
first means for adjusting said characteristic counter;
first means for comparing said characteristic counter against a first pre-determined value;
second means for determining whether said characteristic counter is equal to said first pre-determined value; and
first means for repeating acts associated with said means for generating, said means for time-stamping and said means for storing acts if said characteristic counter is not equal to said first pre-determined value.

9. The apparatus according to claim 8, further comprising:
third means for determining a number of scenes in said digital cinema content file;
second means for setting a counter indicative of said number of scenes in said digital cinema content file;
second means for adjusting said scene counter;
second means for comparing said scene counter against a second pre-determined value;
fourth means for determining whether said scene counter is equal to said second pre-determined value;
second means for repeating acts associated with said means for accepting, said means for selecting, said first means for determining, said means for generating, said means for time-stamping, said means for storing, said first means for setting, said first means for adjusting, said first means for comparing, said second means for determining and said first means for repeating if said scene counter is not equal to said second pre-determined value.

10. The apparatus according to claim 7, further comprising means for compressing said scene build.

11. A method for embedding forensic information in digital cinema content, said method comprising:
first accepting a digital cinema content file having therein a plurality of scene builds;
second accepting a forensic code; and
selecting a scene build from said digital cinema content file based on said forensic code.

12. The method according to claim 11, further comprising displaying said selected scene build.

13. The method according to claim 11, in which said plurality of scene builds are compressed, further comprising decompressing said selected scene build.

14. The method according to claim 12, further comprising:
determining a selected number of scenes in said digital cinema content file;
setting a counter indicative of said selected number of scenes in said digital cinema content file;
adjusting said scene counter;
comparing said scene counter against a pre-determined value;
determining whether said scene counter is equal to said pre-determined value;
repeating said first accepting, said second accepting and said selecting acts if said scene counter is not equal to said pre-determined value.

15. The method according to claim 11, further comprising decrypting said digital cinema content file with a security key.

16. The method according to claim 11, further comprising decrypting said forensic code with a security key.

17. An apparatus for embedding forensic information in digital cinema content, comprising:
first means for accepting a digital cinema content file having therein a plurality of scene builds;
second means for accepting a forensic code; and
means for selecting a scene build from said digital cinema content file based on said forensic code.

18. The apparatus according to claim 17, further comprising means for displaying said selected scene build.

19. The apparatus according to claim 17, further comprising means for decompressing said selected scene build.

20. The apparatus according to claim 18, further comprising:
first means for determining a selected number of scenes in said digital cinema content file;
means for setting a counter indicative of said selected number of scenes in said digital cinema content file;
means for adjusting said scene counter;
means for comparing said scene counter against a pre-determined value;
second means for determining whether said scene counter is equal to said pre-determined value;
means for repeating said first accepting, said second accepting and said selecting acts if said scene counter is not equal to said pre-determined value.

21. The apparatus according to claim 17, further comprising means for decrypting said digital cinema content file with a security key.

22. The apparatus according to claim 17, further comprising means for decrypting said forensic code with a security key.
